(19) United States
(12) Patent Application Publication
(10) Pub. No.: US 2015/0358713 A1
(43) Pub. Date: Dec. 10, 2015

(54) Earbud cable management device

(71) Applicant: Greg Fisher, Berkeley, CA (US)

(72) Inventor: Greg Fisher, Berkeley, CA (US)

(21) Appl. No.: 14/120,601

(22) Filed: Jun. 9, 2014

(51) Int. Cl. H04R 1/10

(52) U.S. Cl. CPC H04R 1/1033

(57) ABSTRACT

An earbud cable management device with a jack cable and attached jack, a flexible earbud cable, a pair of earbud speakers, a malleable metal rod, a rubber-like coating and a central housing. The jack cable protrudes in a parallel fashion from the central housing. The earbud cable extends from the central housing and terminates in the earbud speakers. The malleable metal rod protrudes approximately two inches in a parallel fashion from the central housing. The rubber-like coating surrounds the malleable metal rod. The rubber coated malleable metal rod is capable of being bent by the user to removably retain the flexible earbud cable and jack cable in a compact coiled condition. A preferred embodiment includes the malleable metal rod being made of copper having a diameter of approximately eighty thousandths of an inch.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of audio accessories and more specifically to an earbud cable management device.

Earbud type speakers are compact and fit snuggly in the user's ear. They are frequently used in conjunction with digital media players such as Smart Phones, tablets, laptop computers and MP3 players.

In recent years many products have become available to help retain the earbud cable in a neat and untangled condition.

However, there is a deficiency in the prior designs in that they all involve a separate piece of equipment to do the job. The cable is usually wound around a plastic retaining device that is separate from the cable and therefore prone to getting misplaced. Additionally, many of the current cable organizers are designed to hold a specific length and thickness of cable and require the user to carefully wind the cable in the right tension so that the earbuds end up in the correct location when the cable is fully wound.

### BRIEF SUMMARY OF THE INVENTION

The primary object of the invention is to provide a cable management system for earbuds that is compact, and permanently attached to the jack of the earbud so it can never be lost.

Another object of the invention is to provide a cable management system for earbuds that is adaptable to a variety of lengths and thickness of cable.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an earbud cable management device comprising: an earbud jack and cable, a flexible earbud cable, a pair of earbud speakers, a malleable metal rod, a rubber-like coating, a central housing, said jack cable protruding in a parallel fashion from said central housing, said earbud cable extending from said central housing and terminating in said earbud speakers, said malleable metal rod protruding approximately two inches in a parallel fashion from said central housing, said rubber-like coating surrounding said malleable metal rod, and said rubber coated malleable metal rod capable of being bent by the user to removably retain said flexible earbud cable and said jack cable in a compact coiled condition.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention in the unfolded position.

FIG. 2 is a perspective view of the invention in the folded position.

FIG. 3 is a top plan view of an alternate embodiment of the invention.

FIG. 4 is a top plan view of a second alternate embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

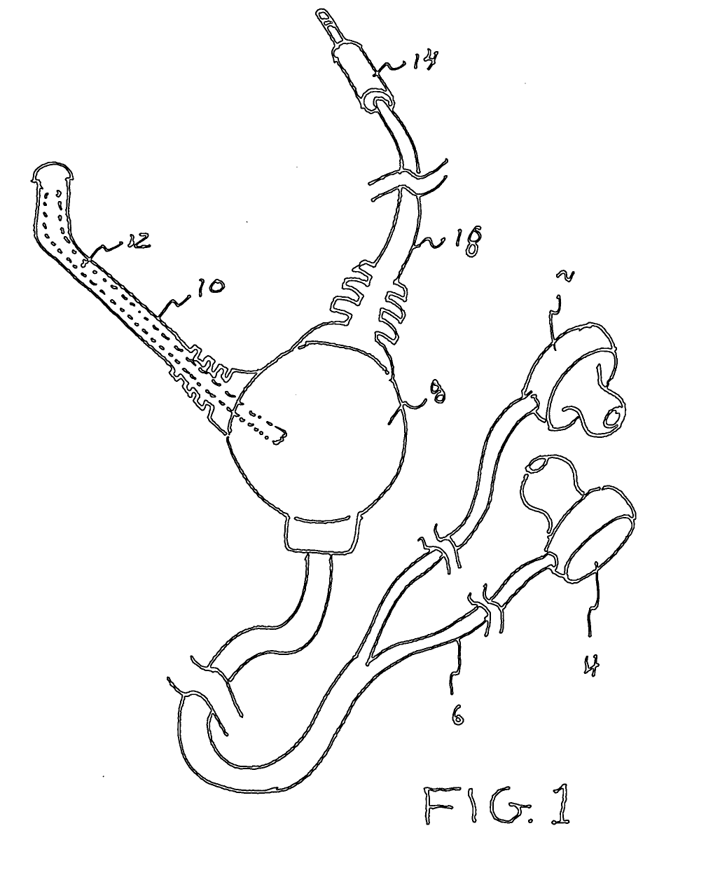

Referring now to FIG. 1 we see the present invention in its unfolded positron. An earbud cable 6 extends from a central housing 8 in a parallel orientation to the housing 8. A jack cable 18 also extends from the central housing 8 in a parallel fashion. The wires inside jack cable 18 and the wires inside earbud cable 6 attach to each other in a standard way within central housing 8. A metal rod shown by dotted line 12 extends in a parallel orientation from inside the central housing to approximately two inches beyond the housing. The rod 12 is coated with a rubber-like coating 10. The coating can be co-molded from a TPE plastic such as forty shore polyurethane. The rubber-like coating 10 protects the cable and the user from being disturbed by the potentially sharp end of the metal rod 12. The metal rod is preferably made of a copper wire approximately eighty thousandths of an inch in diameter. The properties of copper allow the rod 12 to be bent relatively easily, and to hold its shape once bent. It also is capable of being bent numerous times without cracking or breaking. It should be noted that the present invention can work without use of the rubber-like coating 10, however, from a comfort point of view, a soft coating would be advantageous in that it would eliminate the chance of sharp corners coming in contact with the user's ear or face.

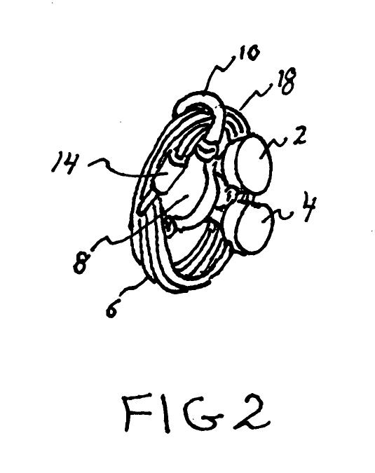

It should also be noted that, even though FIG. 1 and FIG. 2 show the invention in relation to an earbud type earphone, the present invention can also be used in combination with other standard earphone devices including single ear devices.

Additionally, although the preferred embodiment of the invention shows the metal rod 12 attached to a central housing 8, the rod 12 may also be attached to the cable 18 directly by some other standard means, without the need for central housing 8. Central housing 8 is preferable because it acts as a junction point for all associated cables as well as a secure fastening member for metal rod 12.

Furthermore, it is to be understood that the present invention can be used in conjunction with a single earbud or earphone, or a pair of earbuds or earphones.

FIG. 2 is a perspective view of the invention in the folded position. The jack cable 18 and the earbud cable 6 have been coiled and rod 12 covered by rubber-like coating 10 has been bent to retain the coil. In this way, the earbuds 24, jack 14 and cables 6, 18 are held in an orderly compact condition when not in use. The fact that the malleable rod 12 is integral to the entire earbud and jack assembly means that the device for holding the cables in an organized and compact position cannot be lost and is always available for use. Because there is no structural part to wind the cables around, as found in other cable organizing devices, the user can control the compactness of the cable coil and the resulting location of the earbuds and jack.

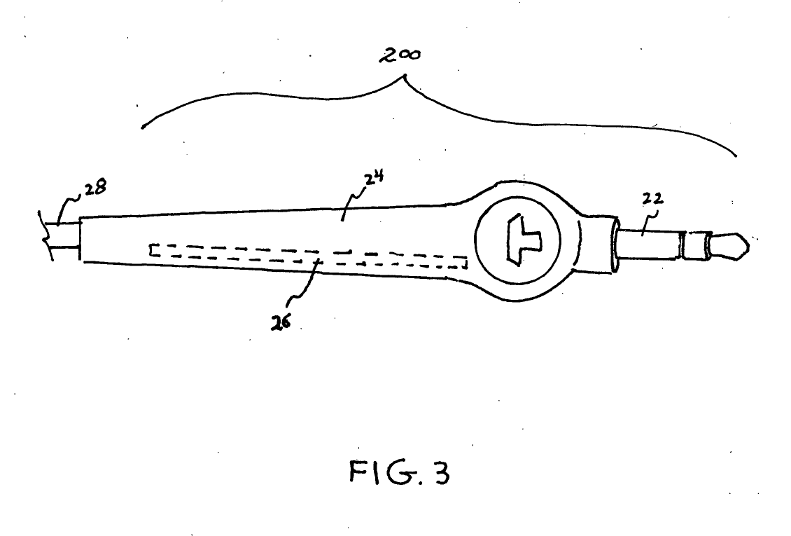

In an alternate embodiment 200 shown in FIG. 3, the malleable rod, shown by dotted line 26 is embedded within the rubber-like molded housing 24 where the jack portion 22 is protruding from one end of the housing 24 and the cable 28 leading to the earbuds is protruding from the opposite end of the housing 24. In this version, the user would form a looped ring of cable 28 and use the extended portion of housing 24 which contains the malleable rod 26 to wrap around the loop of cable to hold it in place.

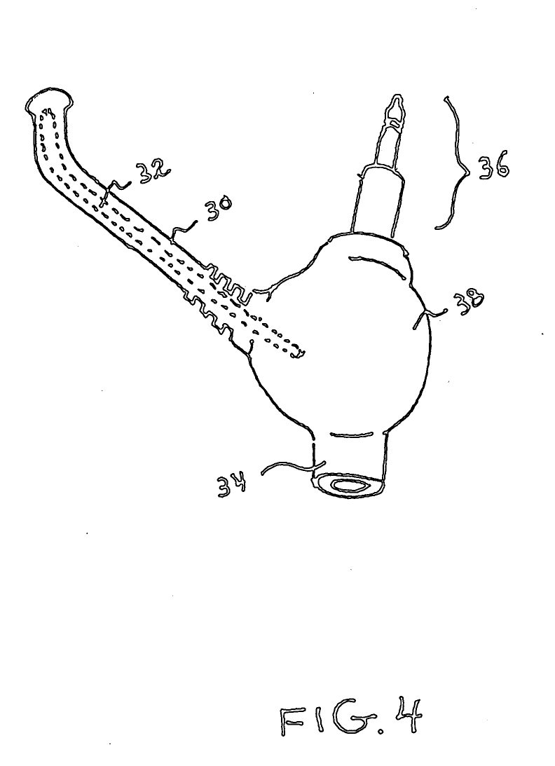

FIG. 4 shows a second alternate embodiment of the invention where the central housing 38 now has a female socket 34 that has replaced earbud cable 6. Additionally the jack 14 and attached cable 18 have been replaced by jack 36 which extends directly from central housing 38.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. an earbud cable management device comprising:
a jack and attached cable;
a flexible earbud cable;
one or more earbud speakers;
a malleable metal rod;
a central housing;
said jack cable extending from said central housing;
said earbud cable extending from said central housing and terminating in said earbud speakers;
said malleable metal rod protruding approximately two inches from said central housing;
said metal rod capable of being bent by the user to removably retain said flexible earbud cable in a compact coiled condition.

2. An earbud cable management device as claimed in claim 1 wherein said metal rod is covered by a rubber-like coating

3. An earbud cable management device as claimed in claim 1 wherein said malleable metal rod is made of copper having a diameter of approximately eighty thousandths of an inch.

4. An earbud cable management device as claimed in claim 2 wherein said rubber-like coating is forty shore polyurethane.

5. An alternate embodiment of the said earbud cable management device as claimed in claim 1 wherein said malleable rod is embedded within an elongated version of said central housing and wherein said jack member is extending from one end of said central housing and said flexible earbud cable is extending from the opposite end of said central housing.

6. A second alternate embodiment of the said earbud cable management device as claimed in claim 1 wherein said earbud cable is removed and replaced by a female jack receptacle and where said jack cable is removed and replaced by a male jack.
